(19) United States
(12) Patent Application Publication
(10) Pub. No.: US 2026/0342794 A1
(43) Pub. Date: Oct. 29, 2026

(54) PROCESSING APPARATUS, PROCESSING METHOD, AND PROCESSING PROGRAM

(71) Applicant: NTT, Inc., Tokyo (JP)

(72) Inventors: Daiki CHIBA, Chiyoda-ku, Tokyo (JP); Naoki FUKUSHI, Chiyoda-ku, Tokyo (JP); Hiroki NAKANO, Chiyoda-ku, Tokyo (JP); Takashi KOIDE, Chiyoda-ku, Tokyo (JP)

(73) Assignee: NTT, Inc., Tokyo (JP)

(21) Appl. No.: 19/486,053

(22) PCT Filed: May 29, 2024
(86) PCT No.: PCT/JP2024/019773

§ 371 Date: Nov. 20, 2025

(30) Foreign Application Priority Data
May 31, 2023 (JP) 2023-090524

(51) Int. Cl. H04L 9/40; G06F 16/951

(52) U.S. Cl. CPC H04L 63/101; G06F 16/951; H04L 63/0823

(57) ABSTRACT

A processing apparatus includes a memory and processing circuitry configured to select a reliable site as a seed, perform, a plurality of times, Web crawling for extracting an external link from the site selected as the seed, perform, based on the site selected as the seed and a domain name of the external link extracted, Domain Name System crawling for extracting a Domain Name System record, and specify a reliable site based on a feature of information extracted by the Web crawling and/or a feature of information extracted by the Domain Name System crawling and generate an allow list indicating the reliable site.

### FIELD The present invention relates to a processing apparatus, a processing method, and a processing program.

### BACKGROUND

An allow list is a list in which sites determined beforehand as reliable based on specific criteria are collected. The sites placed in the allow list are excluded from malignancy determination and regarded as sites without malice (regular sites or benign sites). Note that the allow list is sometimes called safe list or white list as well.

The allow list is generally often used in the Web security field in order to reduce a problem of “erroneous detection” in which a Web site without malice is erroneously recognized as a Web site with malice.

Here, a Web space is extremely vast and has a characteristic of being dynamically continued to be updated. Therefore, it is difficult to manually and comprehensively select reliable sites and continuously update the allow list and continue to maintain the allow list.

As a result, based on the implicit assumption that “being popular is highly likely to be safe”, the “top list” has been widely used as a virtual allow list in both the industry and academic circles concerning security.

The top list is a ranking list in which Web sites and domain names are arranged in order of popularity on a specific basis. There are a plurality of top lists, and a definition of data used in each of the top lists, a definition of “popularity”, an aggregation method, and the like are greatly different.

In general, there is a Tranco Top Million List (Non Patent Literature 1) as a representative top list widely used. The Tranco Top Million List is obtained by combining top lists of Alexa Top 1 Million, Cisco Umbrella 1 Million, and Majestic Million. The Alexa Top 1 Million is one of the most often utilized top lists and is decided based on the average number of visits to a Web site and page views per day. The Cisco Umbrella 1 Million is a list in which the most popular domain names are ranked in order based on DNS observation in the DNS (Domain Name System) service provided by Cisco Umbrella (registered trademark). The Majestic Million is a list in which popularity of Web sites is calculated based on Web links provided by Majestic SEO (registered trademark).

In addition, the Secrank List (Non Patent Literature 2) uses a voting algorithm based on DNS request amounts of domain names in a new top list processing method. There is also a Chrome User Experience Report (CrUX) in which popularity of Web sites is ranked based on data collected from users of the Web browser Google Chrome (registered trademark).

### CITATION LIST

### Non Patent Literature

Non Patent Literature 1: Victor Le Pochat et al., “TRANCO: A Research-Oriented Top Sites Ranking Hardened Against Manipulation”, In: Proc. NDSS (2019).
Non Patent Literature 2: Qinge Xie, et al., “Building an Open, Robust, and Stable Voting-Based Domain Top List”, In: Proc. USENIX Security (2022).

### SUMMARY

### Technical Problem

Examples of using the top list as a substantial allow list can be roughly divided into the following two examples.

For example, a first example of using the top list as removal of erroneous detection is explained. In order to prevent erroneous detection, there is an example in which a domain name of the top list of Majestic is used as an allow list. In MISP (Malware Information Sharing Platform), which is an Open Source Threat Intelligence Platform, Alexa Top1k, Umbrella Top 20k, Majestic Toplk, and Tranco Top 10k are used as options for eliminating erroneous detection.

A second example of using the top list as benign labeling is explained. When machine learning is used in the security field, the top list is widely used in, for example, processing used to label domain names as “benign”, processing of excluding some domain names from analysis targets as “benign” in an analysis process, and the like.

Furthermore, when a phishing site is detected, there are many examples in which a domain name listed at a high rank in the top list is selected as a “genuine” imitating a domain name.

However, since the top list is originally a mechanism of sequentially listing “popular” sites, there is a problem in that “a not-popular but benign sites” are fundamentally less easily posted. For example, a site of a new company, a site of a new service of an existing company, a site of a service provided for a specific region, and the like are hardly posted on the top list.

If such sites are not posted, erroneous detection occurs when a malicious site is specified or access to the malicious site is controlled (filtered), a regular site is erroneously determined as malicious, or a regular site that is not so popular and a phishing site are not distinguished.

The present invention has been made in view of the above, and an object of the present invention is to provide a processing apparatus, a processing method, and a processing program capable of generating an allow list correctly indicating “a not-popular but regular site” to implement accuracy improvement in specifying a malicious site and controlling access to the malicious site.

### Solution to Problem

In order to solve the above-mentioned problems and achieve the object, a processing apparatus includes: a selection unit that selects a reliable site as a seed; a first extraction unit that performs, a plurality of times, Web crawling for extracting an external link from the site selected as the seed; a second extraction unit that performs, based on the site selected as the seed and a domain name of the external link extracted by the first extraction unit, DNS crawling for extracting a DNS record; and a generation unit that specifies a reliable site based on a feature of information extracted by the Web crawling and/or a feature of information extracted by the DNS crawling and generates an allow list indicating the reliable site.

### Advantageous Effects of Invention

According to the present invention, it is possible to generate an allow list correctly indicating “a not-popular but regular site” and implement accuracy improvement in specifying a malicious site and controlling access to the malicious site.

### BRIEF DESCRIPTION OF DRAWINGS

FIG. 1 is a diagram illustrating an example of a configuration of a processing apparatus according to an embodiment.

FIG. 2 is a diagram illustrating an overview of collection targets and processing for the collection targets at the time of Web crawling.

FIG. 3 is a diagram for explaining first to fifth feature vectors.

FIG. 4 is a diagram for explaining the first to fifth feature vectors.

FIG. 5 is a flowchart illustrating a processing procedure of processing executed by the processing apparatus illustrated in FIG. 1.

FIG. 6 is a flowchart illustrating a processing procedure of generation processing illustrated in FIG. 5.

FIG. 7 is a flowchart illustrating a processing procedure of a re-execution algorithm executed by a decision unit.

FIG. 8 is a diagram for explaining a hierarchical ring model.

FIG. 9 is a flowchart illustrating a processing procedure of labeling processing.

FIG. 10 is a flowchart illustrating a processing procedure of first determination processing illustrated in FIG. 9.

FIG. 11 is a flowchart illustrating a processing procedure of second determination processing illustrated in FIG. 9.

FIG. 12 is a flowchart illustrating a processing procedure of third determination processing illustrated in FIG. 9.

FIG. 13 is a flowchart illustrating a processing procedure of fourth determination processing illustrated in FIG. 9.

FIG. 14 is a flowchart illustrating a processing procedure of fifth determination processing illustrated in FIG. 9.

FIG. 15 is a diagram illustrating an example of a computer that executes a processing program.

### DESCRIPTION OF EMBODIMENTS

Hereinafter, embodiments of a processing apparatus, a processing method, and a processing program according to the present application are explained in detail with reference to the drawings. Note that the present invention is not limited to the embodiments explained below.

The processing apparatus according to the embodiment generates a new allow list starting from a regular Web site rather than a top-down approach depending on popularity.

The processing apparatus selects a small number of reliable Web sites as seeds. The processing apparatus performs Web crawling on sites of these seeds and, when being externally linked from the sites of the seeds, extracts domain names, Web content, and DNS (Domain Name System) records of the sites.

Then, the processing apparatus eliminates unreliable domain names by executing machine learning using Web content concerning an external link found during the crawling and features concerning the DNS record. Then, the processing apparatus specifies reliable sites and finally generates an allow list that is the latest at the point in time.

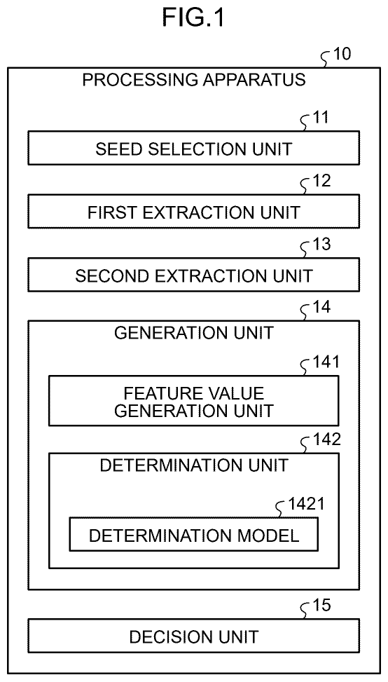

As explained above, the processing apparatus uses a relationship of links forming the basis of a Web space and feature information in a network structure and uses information concerning a small number of known unreliable domain names as labels to specify and eliminate unreliable domain names among domain names that have not been determined yet. Accordingly, the processing apparatus is capable of correctly specifying “a not-popular but regular site” overlooked in the top list and can specify a malicious site with less erroneous detection and high accuracy and can control access to the malicious site.

[Processing apparatus] Subsequently, a configuration of the processing apparatus according to the embodiment is explained. FIG. 1 is a diagram illustrating an example of the configuration of the processing apparatus according to the embodiment.

A processing apparatus 10 according to the embodiment is a server apparatus implemented by, for example, a predetermined program being read by a computer or the like including a ROM (Read Only Memory), a RAM (Random Access Memory) and a CPU (Central Processing Unit) and the CPU executing the predetermined program. The processing apparatus 10 includes a communication interface that transmits and receives various kinds of information to and from other apparatuses connected via a network or the like. As explained below, the processing apparatus 10 has a crawling function of moving around links to look around Web sites and copying and storing information present in Web pages and DNS records.

As illustrated in FIG. 1, the processing apparatus 10 includes a seed selection unit 11 (a selection unit), a first extraction unit 12, a second extraction unit 13, a generation unit 14, and a decision unit 15.

The seed selection unit 11 selects reliable Web sites as seeds and creates a seed list indicating the selected Web sites.

The first extraction unit 12 performs Web crawling on the Web sites shown in the seed list and specifies and extracts, together with Web content obtained by access of the Web crawling at this time, domain names externally linked from the Web sites selected as the seeds.

The second extraction unit 13 performs additional DNS crawling on the domain names found in the external link from the seeds and refers to and extracts a DNS record that cannot be obtained only by Web crawling.

The generation unit 14 specifies reliable sites based on features of information extracted by the Web crawling and/or features of information extracted by the DNS crawling and generates an allow list indicating the reliable sites.

The generation unit 14 generates a list indicating the specified domain names as an allow list and outputs the allow list. The allow list is a list of sites in which sites determined beforehand as reliable based on specific criteria are collected. The sites posted in the allow list are excluded from malignancy determination and are considered as sites without malice (regular sites or benign sites).

The decision unit 15 decides timing when the first extraction unit 12, the second extraction unit 13, and the generation unit 14 re-execute these procedures.

[Seed selection unit] Seed creation processing executed by the seed selection unit 11 is explained. The seed selection unit 11 selects a limited number of reliable Web sites as seeds and creates a seed list showing the selected seeds.

The seed selection unit 11 adopts, for example, a method of selecting an official site of a listed company as a selection method for reliable Web sites. The seed selection unit 11 lists listed companies in country markets and selects official pages of the listed companies as seeds.

The method is based on the following assumptions. Listed companies are legally obliged to disclose information. Although there are a plurality of means as a method of disclosing information, in general, many companies prepare Web sites as the means and provide IR (Investor Relation) information. For this reason, it is assumed that Web sites of the listed companies are relatively reliable in the Web space. However, it is necessary to pay attention to the fact that there is naturally a possibility that falsification is performed or sufficient maintenance is not performed even in the Web sites of the listed companies.

The seeds selected by the seed selection unit 11 are merely a starting point for executing the subsequent processing. Determination as to whether to select domain names in a final allow list is executed again by the subsequent functional components. For this reason, it is unnecessary for the seed selection unit 11 to select a Web site that is 100% reliable.

Two specific selection examples of listed companies are explained. A first one is a method using a list such as “Forbes Global 2000” issued by Forbes (registered trademark) every year. The Forbes Global 2000 is a list of top 2000 companies ranked based on various criteria such as sales, net assets, total market values, and profits as indicators of company sizes and includes many listed companies in the world.

The second one is a method of selecting companies listed on stock markets in countries. For example, in Japan, listed companies of the Tokyo Stock Exchange can be selected. Similarly, listed companies of the countries in the world can also be selected.

In the selection examples explained above, even if a listed company is selected, a URL and a domain name of an official site of the company are not uniquely decided only by a company name.

Thus, for example, a search engine or the like is used and a page displayed at the top when a character string such as “official site” is added in addition to “company name” and searched is selected as the URL of the official site.

Note that, in an EC (Electric Commerce) company or the like, a top page for general customers (example: https://www.amazon[.]com/) and a company home page (example: https://www.aboutamazon[.]com/) are sometimes prepared as different domain names and, in the present embodiment, it is assumed that the latter is mainly used.

Note that the seed list creation method is not limited to the methods explained above, and a method of manually selecting reliable sites or another method may be adopted.

[First extraction unit] First extraction processing executed by the first extraction unit 12 is explained. The first extraction unit 12 executes Web crawling for the URLs included in the seed list created by the seed selection unit 11. The first extraction unit 12 extracts, together with server certificate information and Web content information, a link included in a Web page obtained by the Web crawling and stores the link with a time stamp at the time of the Web crawling execution added to the link.

Specifically, the first extraction unit 12 extracts links by recursively repeating the Web crawling up to a designated layer (depth) based on the sites selected as the seeds. The first extraction unit 12 determines, according to a domain name of the extracted link, whether the extracted link is an external link and extracts server certificate information and Web content information when the extracted link is an external link.

The first extraction unit 12 performs one of the following first processing and second processing on the extracted links according to a PLD (Pay Level Domain).

Note that the PLD is a minimum unit of a domain that the user can directly register and is configured by a public suffix subdomain (for example, “.com” and “co.uk”). It is necessary to pay attention to the fact that consistent terms are not always used for these appellations in the industry. For example, the public suffix is sometimes called effective top-level domain (eTLD). As other terms having the same meaning as the PLD, there are registrable domain name (registrable domain), eTLD+1, apex domain, and effective second (2nd) level domain (eSLD/e2LD).

First processing is processing of, when a PLD of a link destination coincides with a PLD of a seed, recursively repeating Web crawling processing until reaching a layer (depth) designated in advance, performing Web access to the link destination again, and extracting a link.

Second processing is processing of, when a PLD of a link destination does not coincide with a PLD of a seed, performing Web access to the link destination only once, collecting content (server certificate information and Web content information), and completing extraction.

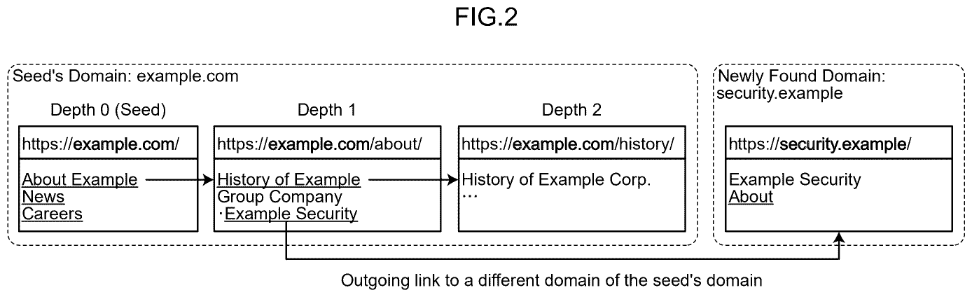

FIG. 2 is a diagram illustrating an overview of collection targets and processing therefor at the time of Web crawling. For example, in FIG. 2, when a URL of a seed is “https://example[.]com” and the depth is 0, a link “https://example[.]com/about/” having the same PLD at the next depth (Depth 1) is listed again as link extraction target (the first processing). On the other hand, an external link “https://security[.]example/”, a PLD of which does not coincide is accessed up to the URL but is not accessed ahead of the page (the second processing).

[Second extraction unit] Second extraction processing executed by the second extraction unit 13 is explained. The second extraction unit 13 additionally performs the DNS crawling on all domain names found in the Web crawling. The second extraction unit 13 executes the DNS crawling based on a site selected as a seed and a domain name of an external link extracted by the first extraction unit 12 and extracts a DNS record and a correspondence status of a DNS security mechanism.

Specifically, first, the second extraction unit 13 collects five types of general DNS records (NS, A, AAAA, MX, and TXT) of domain names. The second extraction unit 13 further collects, when an A record or an AAAA record is present, a country and an organization corresponding to an IP address of the record.

For example, the second extraction unit 13 adopts a method of using a publicly known GeoIP database in order to associate the IP address and the country or the organization corresponding thereto.

Further, the second extraction unit 13 verifies to what extent domains comply with seven DNS security mechanisms (DNSSEC (DNS Security Extension), CAA (Certification Authority Authorization), SPF (Sender Policy Framework), DKIM (DomainKeys Identified Mail), Domain-based Message Authentication, Reporting, and Conformance (DMARC), Mail Transfer Agent Strict Transport Security (MTA-STS), and DNS-based authentication of named entities (DANE)) and collects information concerning the compliance.

Note that a security mechanism used in a DNS set as a target in the present embodiment targets the above but is not limited thereto because a new protocol or scheme (for example, Brand Indicators for Message Identification (BIMI)) is proposed and gradually spread year by year.

[Generation unit] Generation processing executed by the generation unit 14 is explained. The generation unit 14 generates, using processing results by the seed selection unit 11, the first extraction unit 12, and the second extraction unit 13, an allow list in which reliable domain names at a certain point in time are listed. The generation unit 14 includes a feature value generation unit 141 and a determination unit 142.

The feature value generation unit 141 generates a feature vector (a feature value) indicating features of a determination target domain name and a Web site concerning the domain name. The feature value generation unit 141 generates a feature vector indicating features of information extracted by the Web crawling. In addition or alternatively, the feature value generation unit 141 generates a feature vector indicating a feature of information extracted by the DNS crawling.

The determination unit 142 determines, using a determination model 1421 (a machine learning model), whether a Web site extracted by the Web crawling is reliable. The determination model 1421 is learned to, when a feature vector indicating features of a determination target domain name and a Web site concerning the domain name is input, output a determination result as to whether a site of the domain name is reliable.

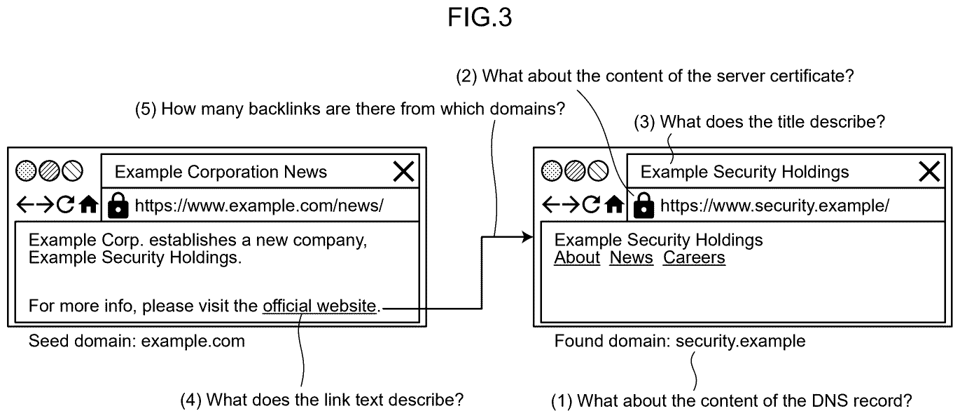

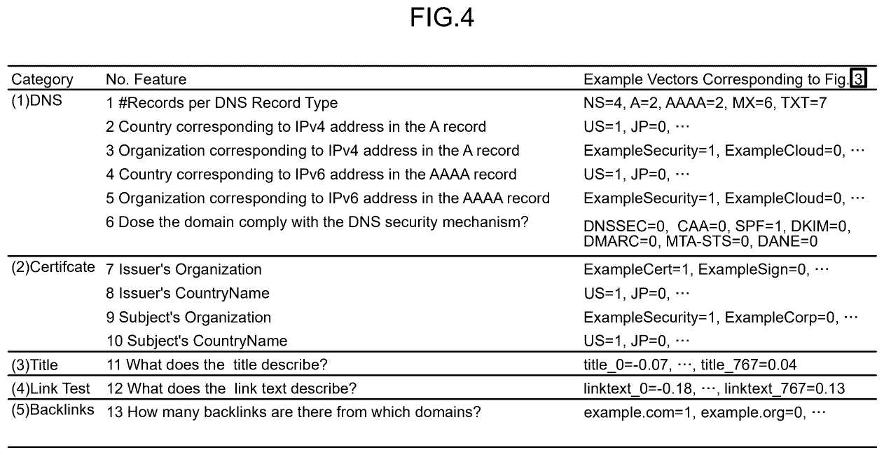

The determination unit 142 inputs the feature vector generated by the feature value generation unit 141 to the determination model 1421. The determination unit 142 eliminates a domain determined as unreliable by acquiring a determination result for a domain name corresponding to the feature vector output by the determination model 1421.

[Processing of the feature vector generation unit] The feature value generation unit 141 generates first to fifth feature vectors based on the information extracted by the Web crawling and/or the information extracted by the DNS crawling. FIG. 3 and FIG. 4 are diagrams for explaining the first to fifth feature vectors.

[First feature vector] First, the first feature vector is explained. The first feature vector indicates features of presence or absence of a DNS record by the DNS crawling and content of a DNS record.

The feature value generation unit 141 determines, from DNS records collected by the DNS crawling by the second extraction unit 13, whether general five types of DNS records (NS, A, AAAA, MX, and TXT) are present and, when the DNS records are present, indicates the number of the DNS records as an element of the first feature vector ((1) in FIGS. 3 and 1 of (1) in FIG. 4).

The feature value generation unit 141 quantifies each of country names and organization names corresponding to IP addresses of the A record and the AAAA record among the DNS records and indicates the country names and the organization names as elements of the first feature vector (2 to 5 of (1) in FIG. 4).

Furthermore, the feature value generation unit 141 quantifies to which degree a domain name conforms to the seven DNS security mechanisms and indicates the degree as an element of the first feature vector (6 of (1) in FIG. 4).

[Second feature vector] Subsequently, the second feature vector is explained. The second feature vector indicates a feature of content of the server certificate information.

The feature value generation unit 141 quantifies four types of content set in an issuer and a subject of the Server certificate, that is, what is set in each of Organization and Country Name of the issuer and Organization and Country Name of the subject ((2) in FIG. 3) and indicates the content as an element of the second feature vector ((2) in FIG. 4).

[Third feature vector] Subsequently, the third feature vector is explained. The third feature vector indicates, for a determination target domain name, a title of a Web site extracted by the Web crawling and/or a feature of a context of a sentence set as content of the Web site extracted by the Web crawling. The third feature vector indicates a feature of context of the title ((3) in FIG. 3 and (3) in FIG. 4). The third feature vector is a feature value concerning what the title represents.

The third feature vector is generated in order to recognize a natural-language context of a title of a Web site of a found domain name and contribute to identifying other domain names having Web sites of titles of the same context. For this reason, the feature value generation unit 141 uses a multi-language model of Sentence BERT in order to generate the third feature vector.

Specifically, the feature value generation unit 141 creates a sentence in which titles of all Web sites having domain names found when a seed list at specific timing is subjected to Web crawling are connected and inputs the sentence to the Sentence BERT model. Accordingly, the feature value generation unit 141 acquires a fixed-dimensional (768 dimensional) third feature vector that does not depend on the number of words of a title.

Note that the Sentence BERT is a language processing model, using a Transformer architecture, for understanding a meaning of a sentence. According to the Sentence BERT, unlike a simple word embedding vector (for example, word2vec), a feature vector considering a sentence relationship can be obtained and high accuracy is achieved in various natural language processing tasks (for example, semantic sentence similarity, semantic search, and clustering).

[Fourth feature vector] Subsequently, the fourth feature vector is explained. The fourth feature vector indicates a feature of context of a document of link text set in a link source of a back link at the time when being linked to the Web site extracted by the Web crawling. The fourth feature vector indicates a feature of a context of the link text ((4) in FIG. 3 and (4) in FIG. 4). The fourth feature vector is a feature value concerning what the link text represents.

Here, the feature value generation unit 141 acquires a fourth feature vector using the Sentence BERT as in the third feature vector generation processing in order to specify a context of a character string set as link text in a link source at the time when being linked to the domain name found by the Web crawling.

Specifically, the feature value generation unit 141 creates a sentence in which link text of a Web site of a seed linked to a target domain name is connected and obtains a feature vector of the Sentence BERT.

Accordingly, the feature value generation unit 141 acquires an additional 768-dimensional feature vector independent of the third feature vector as the fourth feature vector.

[Fifth feature vector] Subsequently, the fifth feature vector is explained. The fifth feature vector indicates, for a determination target domain name, features of the number of Web sites linked to the Web site extracted by the Web crawling and a domain name of a back link source. The fifth feature vector quantifies how many back links are made from which domain name and indicates the back links of the domain name as an element of the fifth feature vector.

The feature value generation unit 141 configures a feature vector indicating features of the number of back links linked to a Web site of a target domain name and the domain name.

For example, in the case of FIG. 3, since there is only one back link linked to the Web site of the target domain name ((5) in FIG. 3), the feature value generation unit 141 constructs feature vectors such as “back link from example.com=1” and “back link from another domain=0” ((5) in FIG. 4).

Note that the five categories explained above and feature vectors actually configured are examples, and the feature value generation unit 141 may generate feature vectors of other categories configured using other methods.

[Processing of the determination unit] Then, using the generated first to fifth feature values, the feature value generation unit 141 specifies and eliminates unreliable domain names with a supervised machine learning approach.

In general, in the supervised machine learning, a machine learning model is created using a correct answer label and a feature vector and the machine learning model is applied to new data.

In the present embodiment, when the correct answer label is given, the design of the related art for giving a binary label of “unreliable (positive)” or “reliable (negative)” is not adopted in problem setting.

For example, in the related art, it has been reported that, when machine learning concerning a domain name is performed, very high accuracy can be obtained if a top list is used as a reliable labeling method. This is because the two feature distributions of excessively popular (popular and reliable) and not-popular (unpopular and unreliable) sites are greatly different.

In contrast, an object of the present embodiment is to specify an unpopular but reliable domain name unlike the related art.

If, depending on the top list, as in the related art, a domain name is labeled as to whether the domain name is reliable, features are biased to features of the top list and a machine learning model suitable for specifying an unpopular but reliable domain cannot be output.

Therefore, in order to solve this problem, in the present embodiment, for example, PU (Positive-Unlabeled) learning is utilized.

The PU learning is a technique that utilizes both of positive data and unlabeled data to learn a supervised machine learning model.

In the present embodiment, among teacher data, positive data is data labeled as “unreliable domain name”. Among the teacher data, unlabeled data is configured from both of “a reliable domain name and an unreliable domain name”.

By using the PU learning, a machine learning model (the determination model 1421) not biased to the features of the top list can be learned and an unpopular but reliable domain can be specified.

Note that, by using the PU learning, at the time of labeling, it is possible to avoid work of manually labeling positive (unreliable) data from zero by directly using a result already determined as unreliable by another mechanism.

The determination unit 142 calculates an unreliability probability for the found domain name using the determination model 1421 and determines that a domain name exceeding a designated threshold is unreliable. Note that this threshold can be adjusted to any value.

[Decision unit] Processing of the decision unit 15 is explained. The allow list is insufficient if being simply generated and needs to be updated such that a domain name that is no longer reliable is not posted in the allow list. For this purpose, the first extraction processing, the second extraction processing, and the generation processing need to be re-executed periodically (for example, every week).

Thus, the decision unit 15 decides re-execution timing of the first extraction processing, the second extraction processing, and the generation processing.

Ideally, every time the seed selection unit 11 updates the Web sites in the seed list, all of the first extraction processing, the second extraction processing, and the generation processing are desirably executed again. However, it is unrealistic to continuously monitor the update of all the Web sites without fail because an amount of calculation and an amount of access to the Web sites are extremely large and a burden is large.

The decision unit 15 decides, according to a predetermined re-execution algorithm, re-execution timing for extraction of an external link by the Web crawling, extraction of server certificate information, and extraction of a DNS record among the first extraction processing, the second extraction processing, and the generation processing.

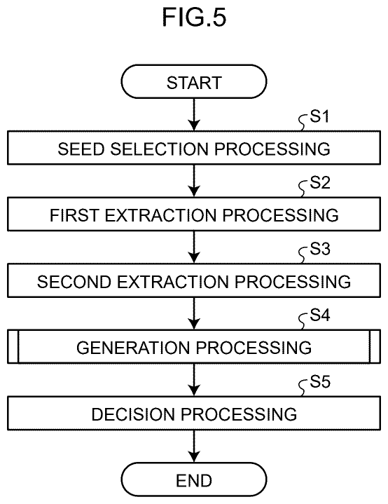

This re-execution algorithm is based on a hypothesis in the embodiment that update information of a Web site required to create an allow list is configured by any one of or a combination of content update, server certificate update, and DNS record update and it is not always necessary to recursively acquire all Web contents every time. The object of the embodiment is not to index the latest Web content all over like a search engine but to collect information necessary for immediately eliminating a domain name that is extracted once as an allow list but is no longer valid at the latest point in time.

[Processing procedure] FIG. 5 is a flowchart illustrating a processing procedure of processing executed by the processing apparatus 10 illustrated in FIG. 1.

The seed selection unit 11 performs seed selection processing of selecting a reliable Web site as a seed and creating a seed list indicating the selected Web site (step S1).

The first extraction unit 12 performs first extraction processing of performing the Web crawling on the Web site shown in the seed list and specifying and extracting, together with Web content obtained by access of the Web crawling at this time, a domain name externally linked from the Web site selected as the seed (step S2).

The second extraction unit 13 performs second extraction processing of performing additional DNS crawling on the domain name found by the external link from the seed and referring to a DNS record that cannot be obtained only by the Web crawling and extracting the DNS record (step S3).

The generation unit 14 performs generation processing of, using the determination model 1421, excluding domain names not reliable at that point in time, specifying reliable domain names, generating a list indicating the specified domain names as an allow list, and outputting the allow list (step S4).

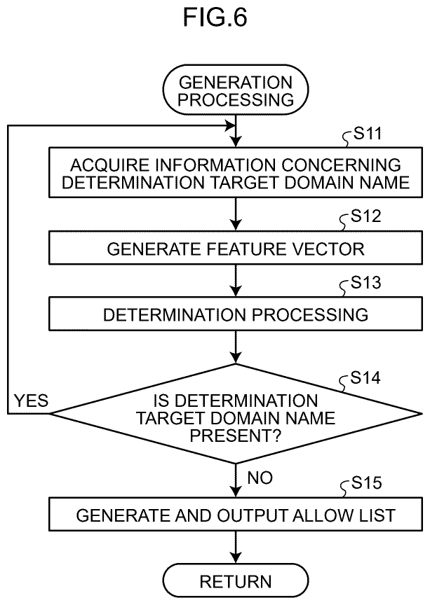

The decision unit 15 performs decision processing of deciding timing for causing the first extraction unit 12, the second extraction unit 13, and the generation unit 14 to re-execute the Web crawling, the extraction of server certificate information, and the extraction of a DNS record (step S5).

[Generation processing] FIG. 6 is a flowchart illustrating a processing procedure of the generation processing illustrated in FIG. 5.

The generation unit 14 acquires information concerning a determination target domain name, specifically, information extracted by the Web crawling and/or information extracted by the DNS crawling (step S11).

The generation unit 14 generates first to fifth feature vectors based on information extracted by the Web crawling and/or information extracted by the DNS crawling (step S12).

The generation unit 14 inputs the first to fifth feature vectors generated in step S12 to the determination model 1421 to acquire an unreliability probability and performs determination processing of determining a domain name exceeding a designated threshold as unreliable (step S13).

When the next determination target domain name is present (step S14: Yes), the generation unit 14 returns to step S11, acquires pieces of information concerning the next determination target domain name, and performs generation and determination processing for a feature vector.

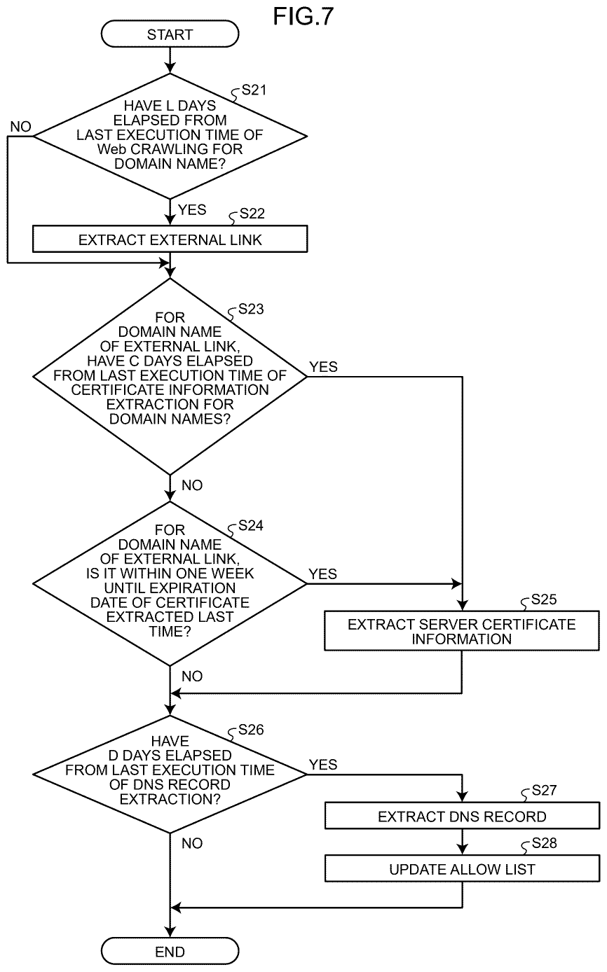

When the next determination target domain name is absent (step S14: No), the generation unit 14 generates, based on a determination result of step S13, a list indicating domain names determined as reliable as an allow list, and outputs the allow list (step S15).

[Re-execution algorithm] FIG. 7 is a flowchart illustrating a processing procedure of a re-execution algorithm executed by the decision unit 15.

First, the decision unit 15 performs the following determination on the domain names described in the seed list created in step S1. The decision unit 15 determines whether L days have elapsed from the last execution time of the Web crawling for the domain names (step S21).

When a domain name (a first domain name) for which L days have elapsed from the last execution time of the Web crawling is present (step S21: Yes), the decision unit 15 causes the first extraction unit 12 to execute the Web crawling for the first domain name again to cause the first extraction unit 12 to re-execute the extraction of an external link (a first external link) (step S22).

When the domain name (the first domain name) for which L days have elapsed from the last execution time of the Web crawling is absent (step S21: No) or after the processing of step S22, the decision unit 15 performs the following processing for the domain names of the first external link extracted when the seed list is subjected to the Web crawling. First, the decision unit 15 determines whether C days have elapsed for extraction of server certificate information for the domain names of the first external link since the last execution time (step S23).

When a domain name (a second domain name) for which C days have elapsed for the extraction of the server certificate information since the last execution time is absent (step S23: No), the decision unit 15 determines whether it is within one week until the expiration date of the server certificate information extracted last time for each domain name of the first external link (step S24).

When a second domain name for which C days have elapsed for the extraction of the server certificate information since the last execution time is present (step S23: Yes) or when a domain name (a third domain name) that is within one week until an expiration date of server certificate information extracted last time is present (step S24: Yes), the decision unit 15 causes the first extraction unit 12 to re-execute the extraction of server certificate information for the domain name (the second domain name or the third domain name) of the external link (step S25).

When the domain name (the third domain name) within one week until the expiration date of the server certificate extracted last time (step S24: No) or after the processing of step S25, the decision unit 15 determines, for the domain names of the first external link, whether D days have elapsed for DNS record extraction for the domain names since the last execution time (step S26).

When a domain name (a fourth domain name) for which D days have elapsed for the DNS record extraction since the last execution time is present (step S26: Yes), the decision unit 15 causes, for the fourth domain name, the second extraction unit 13 to re-execute the extraction of the DNS record (step S27). Then, the generation unit 14 updates the allow list based on processing results of steps S21 to S27 (step S28).

At this time, in the embodiment, by setting parameters to satisfy L>>C≥D, it is possible to reduce a frequency of recursive acquisition to the Web site and collect information necessary for the allow list with a realistic calculation amount and a realistic access amount.

In the above explanation, step S22, step S25, and step S27 describe the processing procedure executed only for the domain names corresponding to the predetermined determination results of step S23, step S24, and step S26 among the domain names of the first external link extracted in step S21. However, the steps are not limited thereto. Steps S22, S25, and S27 may be executed for all the domain names of the first external link extracted in step S21.

[Effects of the embodiment] As explained above, the processing apparatus 10 according to the embodiment selects a small number of reliable Web sites as seeds, performs the Web crawling on the sites selected as the seeds, and extracts an external link. The processing apparatus 10 performs DNS crawling for extracting a DNS record based on the site selected as the seeds and the domain name of the external link extracted by the Web crawling. Then, the processing apparatus 10 specifies reliable sites based on features of information extracted by the Web crawling and/or features of information extracted by the DNS crawling and generates an allow list.

At this time, the processing apparatus 10 eliminates unreliable domain names by executing machine learning using features concerning Web content or a DNS record concerning an external link found during the crawling.

As explained above, the processing apparatus 10 uses the link relationship and the feature information in the network structure that form the basis of the Web space and uses the information concerning the small number of known unreliable domain names as the labels to specify and eliminate the unreliable domain names among the domain names that have not been determined yet.

Accordingly, the processing apparatus 10 is capable of correctly specifying “a not-popular but regular site” that is overlooked in the top list, can specify a malicious site with less erroneous detection and high accuracy, and can control access to the malicious site.

The processing apparatus 10 decides re-execution timing for processing of the Web crawling, extraction of a server certificate, and collection of a DNS record according to a predetermined re-execution algorithm. As explained above, the processing apparatus 10 is capable of generating the latest allow list by continuously executing the processing for specifying reliable sites.

Note that the processing apparatus 10 may perform the determination using only some types of feature vectors among the first to fifth feature vectors.

For example, even if a DNS record is set, when a Web site is not started, content of the Web site is not set. In such a case, the processing apparatus 10 cannot acquire the third feature vector and the fourth feature vector. Thus, for example, the processing apparatus 10 performs determination using only the first feature vector and the second feature vector. In this case, the processing apparatus 10 only has to provide the determination models 1421 for the number corresponding to combinations of input feature vectors and learn the determination models using teacher data corresponding to the combinations of the input feature vectors.

For example, examples of combinations of feature vectors include a combination of the first feature vector and the second feature vector, a combination of the third feature vector and the fourth feature vector, and only the fifth feature vector. In this case, three determination models 1421 are provided to respectively correspond to each of the combination of the first feature vector and the second feature vector, the combination of the third feature vector and the fourth feature vector, and only the fifth feature vector.

The processing apparatus 10 may perform the determination using only some elements of the feature vectors besides using all elements of the feature vectors. For example, the processing apparatus 10 uses only some elements of all the feature vectors, only some elements of the first feature vector and the second feature vector, only some elements of the third feature vector and the fourth feature vector, or only some elements of the fifth feature vector.

In this case, the determination model 1421 performs learning respectively using, as teacher data, feature vectors in which all elements are aligned and sets a numerical value averaged for each of the elements of the feature vectors as a default value. Then, when some elements among the elements of all the feature vectors are not input, the determination model 1421 calculates an unreliability probability assuming that the elements are missing.

The processing apparatus 10 may be provided with the determination model 1421 for the number corresponding to a combination of elements of an input feature vector and perform the determination. The processing apparatus 10 only has to properly use the determination model 1421 according to a type of the input feature vector or the combination of the elements.

[Example of a labeling method] The “unreliable domain name” is labeled using the following method. Note that the labeling may be performed by the processing apparatus 10 or may be performed by another apparatus. In this example, a case in which the processing apparatus 10 executes the labeling is explained as an example. For example, the processing apparatus 10 applies a new ring model to domain names extracted when a URL is subjected to the Web crawling, determines whether the domain name is an unreliable domain name at that point in time, and performs the labeling.

Here, a hierarchical ring model expressing a relationship among a plurality of types of resources relating to Webs or domain names is proposed as a new ring model.

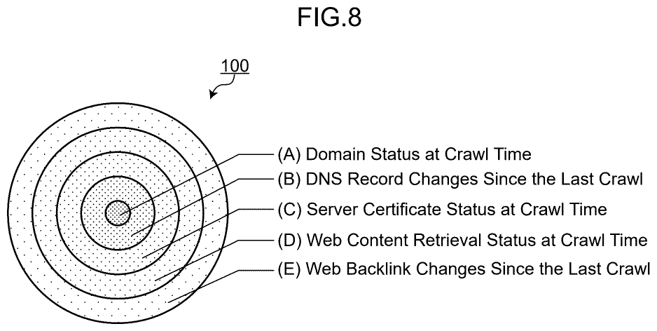

FIG. 8 is a diagram illustrating a hierarchical ring model. As illustrated in FIG. 8, in a hierarchical ring model 100, a state (A) of a domain name at the time of crawling, a change (B) of a DNS record after the last crawling, a server certificate status (C) at the time of crawling, an acquisition status (D) of Web content information at the time of crawling, and a change (E) of a Web back link after the last crawling are arranged in order from the innermost side to the outer side.

The processing apparatus 10 acquires the information of (A) to (E) for a determination target domain name. The processing apparatus 10 expresses the acquired information of (A) to (E) as a hierarchical ring model structure in association with arrangement of rings of the ring model 100.

When a ring on the inner side (for example, (A)) becomes unreliable, the processing apparatus 10 treats the entire ring for this domain name as unreliable even if a ring further on the outer side than this ring (for example, (B)) is trusted and determines that the domain name is unreliable at that point in time.

The processing apparatus 10 outputs only domain names that have passed through all the rings of the ring model 100 as an allow list. That is, the processing apparatus 10 eliminates, based on the hierarchized information (A) to (E), a domain name that is not reliable at the point in time. Note that the ring model 100 explained here is an example and may be a ring model obtained by further expanding indicators adopted as layers of the ring and the number of rings.

The result of the rings is binary (“unreliable” or not). However, “unreliable” is not “reliable”, which means that reliability cannot be determined only by the ring model alone.

Specifically, reliability determination for domain name to which this ring model is applied is performed in the order of first determination processing concerning the state (A) of the domain name at the crawling time, second determination processing concerning the change (B) of the DNS record after the last crawling, third determination processing concerning the state (C) of the server certificate at the crawling time, fourth determination processing concerning the acquisition status (D) of the Web content information at the crawling time, and fifth determination processing concerning the change (E) of the Web back link after the last crawling and ends at a point in time when the state becomes unreliable.

As explained above, for a determination target domain name, the processing apparatus 10 hierarchizes information concerning statuses and temporal change of a plurality of types of resources concerning a Web site, a domain name, and/or a DNS record acquired by the Web crawling with information serving as a starting point of reliability as a higher level and determines whether a site is a reliable site stepwise with reference to the information in order from the top.

[First determination processing] In the first determination processing, when domain parking is used at a point in time of the Web crawling or when an NS record of a domain name is absent (NXDOMAIN), the processing apparatus 10 determines that the domain name is not reliable.

The domain parking is mainly intended to obtain revenue by registering a domain name and guiding users to a Web page including advertisements or links to other Web sites. A domain name using the domain parking or a domain name already abandoned is based on an idea that, even if the domain name provided in the past is reliable, the domain name is regarded as not reliable at the point in time.

Whether a domain name uses the domain parking can be determined, for example, by whether an NS record of the domain name belongs to a known domain parking provider. It is also possible to determine whether the domain name is using the domain parking according to content, substance, and appearance of Web pages.

[Second determination processing] In the second determination processing, the processing apparatus 10 determines, based on a plurality of results acquired by performing re-crawling, that the domain name is not reliable when a combination of NS records of a DNS is different between the last crawling and the current crawling.

The change of the NS records means that a server that designates a domain record has been changed. Naturally, the server is sometimes changed for a legitimate purpose (such as transfer of the server) but the reliability of the domain name needs to be evaluated again at the time of the next re-crawling.

[Third determination processing] In the third determination processing, the processing apparatus 10 determines that, when a link is extracted by the Web crawling, the domain name is not reliable when an expired server certificate is used although the link is extracted as an HTTPS (Hyper Text Transfer Protocol Secure) link. This is because, when the expired server certificate is used for the domain name although the link is extracted as the HTTPS link, management of a server certificate is not satisfactory or the domain name is not reliable because the domain name is highly likely to be a domain name to be abandoned in future.

[Fourth determination processing] In the fourth determination processing, when a Web page cannot be acquired due to a connection error of an HTTPS or an HTTP (Hyper Text Transfer Protocol) at the time of the Web crawling, the processing apparatus 10 determines that the domain name is not reliable. Although it is likely that the server is under maintenance at the time of the Web crawling or that only a specific user can access the server, in the embodiment, safety is considered important and such a site is not posted on a final allow list.

[Fifth determination processing] In the fifth determination processing, when the re-crawling is performed and a plurality of results are present and when the current number of back links is equal to or smaller than the last predetermined ratio, the processing apparatus 10 determines that the site is not reliable. When the current number of back links is equal to or smaller than the last predetermined ratio, links are intentionally deleted from many company sites configuring a seed list. This is because the fact that the sites of the seed list intentionally deleted external links suggests the need to re-evaluate content of the seed list. Note that any numerical value can be adopted as the predetermined ratio (for example, 50%).

### Processing Procedure of Labeling Processing

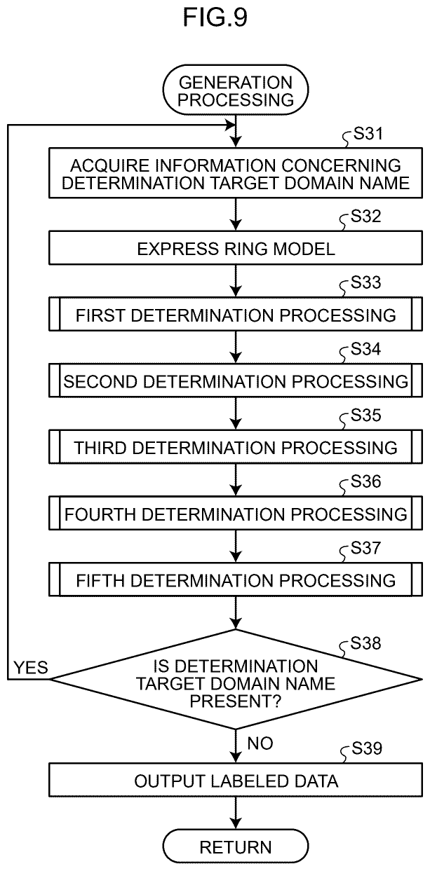

FIG. 9 is a flowchart illustrating a processing procedure of labeling processing.

The processing apparatus 10 acquires information concerning a determination target domain name (step S31). The information concerning the determination target domain name is information concerning a status and a temporal change of a plurality of types of resources concerning Web sites and/or domain names acquired by the Web crawling in the processing in step S4. The information concerning the determination target domain name also includes information concerning the DNS record acquired by the DNS crawling in step S5.

The processing apparatus 10 expresses acquired pieces of information concerning the determination target domain name as a ring model structure hierarchized in association with arrangement of rings of a ring model (see FIG. 3) (step S32).

Subsequently, the processing apparatus 10 determines, from a ring on the inner side of the ring model, whether the determination target domain name is reliable.

Specifically, the processing apparatus 10 performs the determination in the order of first determination processing (step S33) concerning a state (A) of the domain name at the time of the crawling, second determination processing (step S34) concerning a change (B) of a DNS record after the last crawling, third determination processing (step S35) concerning a state (C) of a server certificate at the time of the crawling, fourth determination processing (step S36) concerning an acquisition status (D) of Web content information at the time of the crawling, and fifth determination processing (step S37) concerning a change (E) of a Web back link after the last crawling.

When the next determination target domain name is present (step S38: Yes), the processing apparatus 10 returns to step S31. Then, the processing apparatus 10 acquires pieces of information concerning the next determination target domain name, expresses the information as a ring model structure, and thereafter performs the first determination processing to the fifth determination processing.

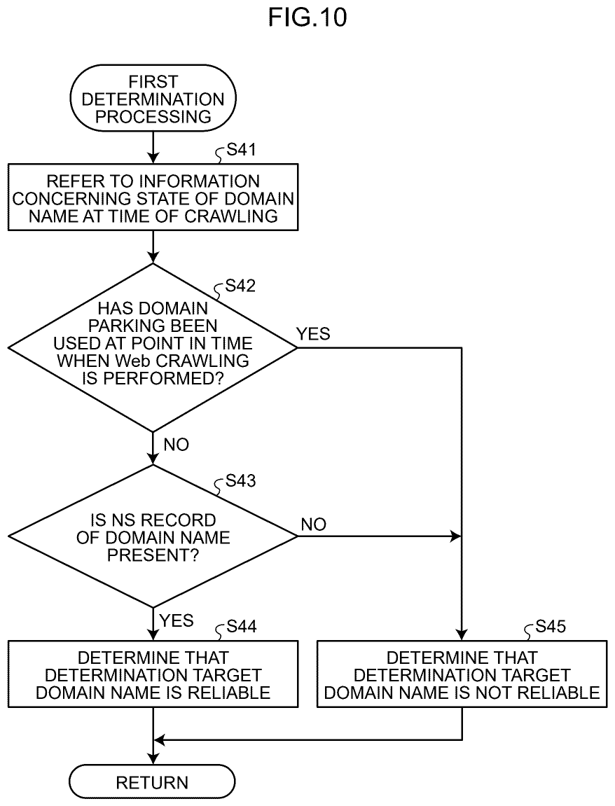

When the next determination target domain name is absent (step S38: No), the processing apparatus 10 adds a label of “not-reliable domain name” to the domain name determined as unreliable based on the determination results in steps S33 to S37 and outputs labeled data (step S39).

[First determination processing] FIG. 10 is a flowchart illustrating a processing procedure of the first determination processing illustrated in FIG. 9.

The processing apparatus 10 refers to the information (A) concerning a status of the domain name at the time of the crawling equivalent to a ring on the innermost side of the ring model (step S41) and determines whether the domain parking has been used at the point in time when the Web crawling is performed (step S42).

When the domain parking has not been used at the point in time when the Web crawling is performed (step S42: No), the processing apparatus 10 determines whether an NS record of the domain name is present (step S43).

When an NS record of the domain name is present (step S43: Yes), the processing apparatus 10 determines that the determination target domain name is reliable (step S44).

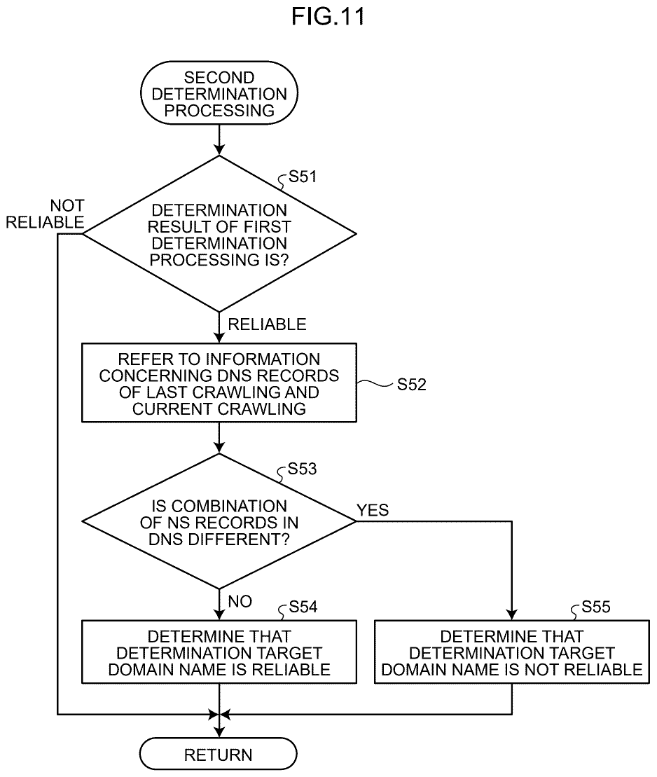

On the other hand, when the domain parking has been used at the point in time when the Web crawling is performed (step S42: Yes) or when a NS record of the domain name is absent (step S43: No), the processing apparatus 10 determines that the determination target domain name is not reliable (step S45).

[Second determination processing] FIG. 11 is a flowchart illustrating a processing procedure of the second determination processing illustrated in FIG. 9.

The processing apparatus 10 determines whether a determination result for the determination target domain name in the first determination processing in the former stage is determination that the domain name is reliable or determination that the domain name is not reliable (step S51).

When determining that the domain name is not reliable (step S51: not reliable), the processing apparatus 10 ends the second determination processing.

When determining that the domain name is reliable (step S51: reliable), the processing apparatus 10 performs the following processing. First, in order to determine the change (B) of the DNS record after the last crawling equivalent to a second ring from the inner side of the ring model, the processing apparatus 10 refers to information concerning DNS records of the last crawling and the current crawling (step S52).

The processing apparatus 10 determines whether a combination of NS records of the DNS is different between the last crawling and the current crawling (step S53).

When the combination of the NS records of the DNS is the same between the last crawling and the current crawling (step S53: No), the processing apparatus 10 determines that the determination target domain name is reliable (step S54).

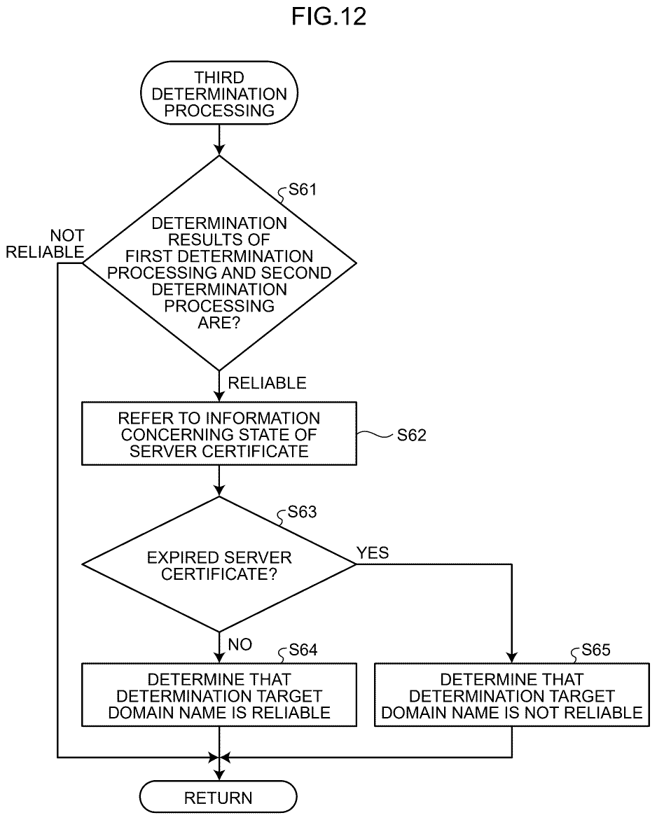

On the other hand, when the combination of the NS records of the DNS is different between the last crawling and the current crawling (step S53: Yes), the processing apparatus 10 determines that the determination target domain name is not reliable (step S55).

[Third determination processing] FIG. 12 is a flowchart illustrating a processing procedure of the third determination processing illustrated in FIG. 9.

The processing apparatus 10 determines whether a determination result for the determination target domain name in the first determination processing and the second determination processing in the former stage is determination that the domain name is reliable or determination that the domain name is not reliable (step S61).

When determining that the domain name is not reliable (step S61: not reliable), the processing apparatus 10 ends the third determination processing.

When determining that the domain name is reliable (step S61: reliable), the processing apparatus 10 refers to information concerning the state (C) of the server certificate at the time of the crawling equivalent to a third ring from the inner side of the ring model (step S62).

Then, the processing apparatus 10 determines whether the server certificate extracted in the Web crawling is an expired server (step S63).

When the server certificate has not expired (step S63: No), the processing apparatus 10 determines that the determination target domain name is reliable (step S64).

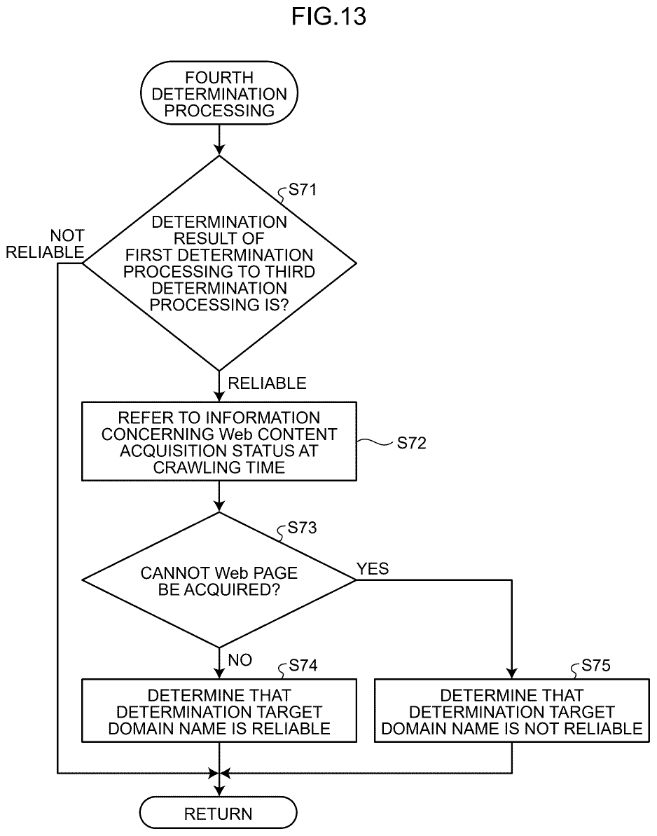

On the other hand, when the server certificate has expired (step S63: Yes), the processing apparatus 10 determines that the determination target domain name is not reliable (step S65).

[Fourth determination processing] FIG. 13 is a flowchart illustrating a processing procedure of the fourth determination process illustrated in FIG. 9.

The processing apparatus 10 determines whether the determination results for the determination target domain name in the first determination processing to the third determination processing in the former stage are determination that the domain name is reliable or determination that the domain name is not reliable (step S71).

When determining that the domain name is not reliable (step S71: not reliable), the processing apparatus 10 ends the fourth determination processing.

When determining that the domain name is reliable (step S71: reliable), the processing apparatus 10 refers to the information concerning the acquisition status (D) of the Web content information at the time of the crawling equivalent to a second ring from the outer side of the ring model (step S72).

The processing apparatus 10 determines whether a Web page has been successfully acquired at the time of the Web crawling (step S73).

When the Web page has been successfully acquired (step S73: No), the processing apparatus 10 determines that the determination target domain name is reliable (step S74).

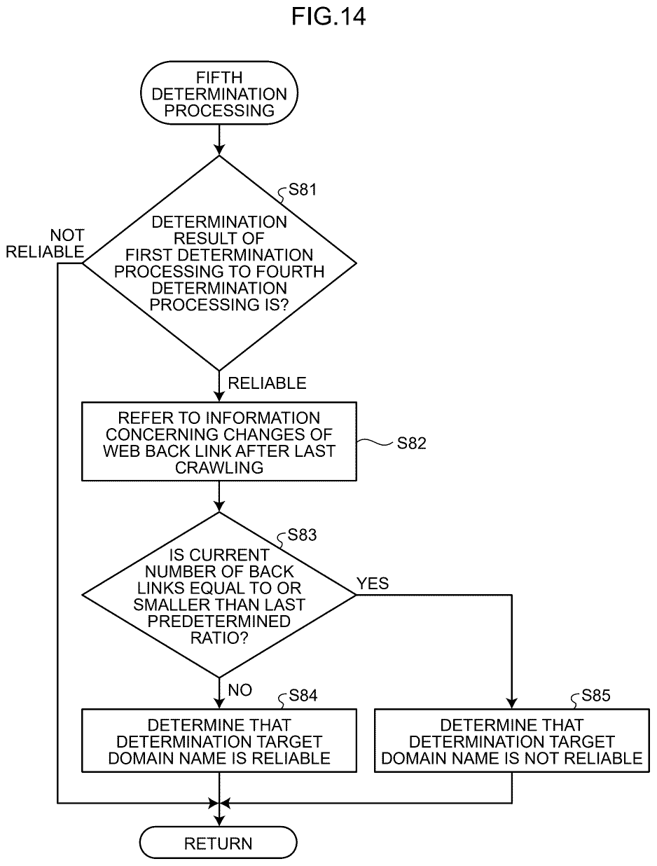

On the other hand, when the Web page has not been successfully acquired (step S73: Yes), the processing apparatus 10 determines that the determination target domain name is not reliable (step S75).

[Fifth determination processing] FIG. 14 is a flowchart illustrating a processing procedure of the fifth determination processing illustrated in FIG. 9.

The processing apparatus 10 determines whether the determination results for the determination target domain name in the first determination processing to the fourth determination processing in the former stage are the determination that the domain name is reliable or the determination that the domain name is not reliable (step S81).

When determining that the domain name is not reliable (step S81: not reliable), the processing apparatus 10 ends the fifth determination processing.

When determining that the domain name is reliable (step S81: reliable), the processing apparatus 10 refers to information concerning the change (E) of the Web back link after the last crawling equivalent to a ring on the outermost side of the ring model (step S82).

The processing apparatus 10 determines whether the current number of back links is equal to or smaller than the last predetermined ratio (step S83).

When the current number of back links is not equal to or smaller than the last predetermined ratio (step S83: No), the processing apparatus 10 determines that the determination target domain name is reliable (step S84).

On the other hand, when the current number of back links is equal to or smaller than the last predetermined ratio (step S83: Yes), the processing apparatus 10 determines that the determination target domain name is not reliable (step S85).

[System configuration and the like] The components of the illustrated apparatuses are functionally conceptual and are not required to be physically configured as illustrated. That is, a specific form of distribution and integration of the apparatuses is not limited to the illustrated form and all or some of the apparatuses can be functionally or physically distributed or integrated in any unit according to various loads, usage situations, and the like. Furthermore, all or some of the processing functions performed in the apparatuses can be implemented by a CPU (Central Processing Unit) and a program analyzed and executed by the CPU or can be implemented as hardware by wired logic. Note that the program may be executed not only by the CPU but also by another processor such as a GPU (Graphics Processing Unit).

Among the kinds of processing explained in the present embodiment, all or some of the kinds of processing explained as being automatically performed can also be manually performed or all or some of the kinds of processing explained as being manually performed can also be automatically performed by a publicly known method. Besides, the processing procedures, the control procedures, the specific names, and the information including various data and parameters illustrated in the document and the drawings can be optionally changed unless specifically noted otherwise.

[Program] As an embodiment, the processing apparatus 10 can be implemented by causing a desired computer to install, as package software or online software, a processing program for executing the processing explained above. For example, by causing an information processing apparatus to execute the processing program explained above, it is possible to cause the information processing apparatus to function as the processing apparatus 10. The information processing apparatus referred to here includes a desktop or notebook personal computer. Besides, the category of the information processing apparatus includes mobile communication terminals such as a smartphone, a mobile phone, and a PHS (Personal Handyphone System) and further includes a slate terminal such as a PDA (Personal Digital Assistant).

The processing apparatus 10 can also be implemented as a server apparatus that sets a terminal device used by a user as a client and provides a service concerning the processing explained above to the client.

For example, the server apparatus is implemented as a server apparatus that provides a service for outputting an allow list. In this case, the server apparatus may be implemented as a Web server or may be implemented as a cloud that provides, by outsourcing, a service concerning the processing explained above.

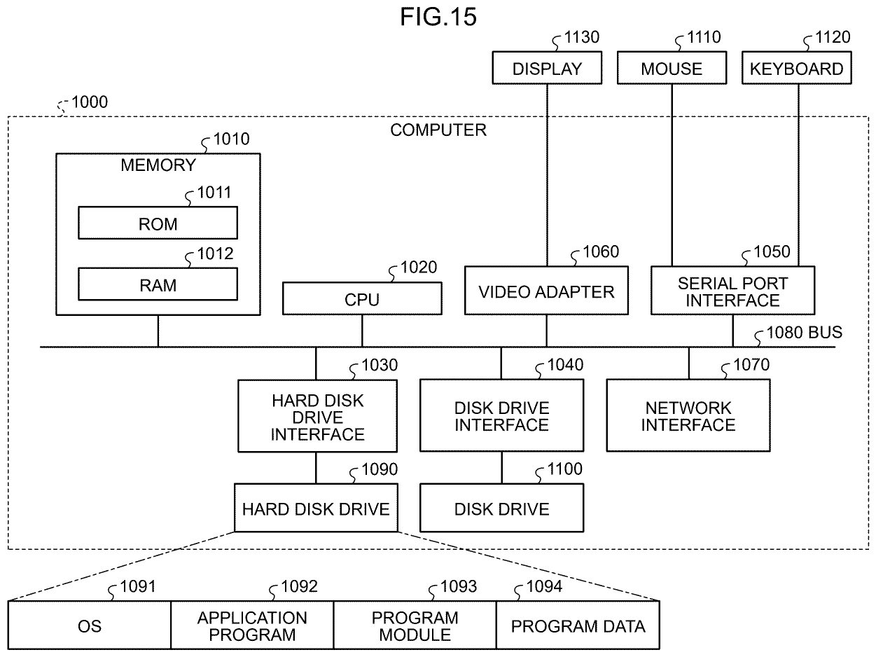

FIG. 15 is a diagram illustrating an example of a computer that executes a processing program. A computer 1000 includes, for example, a memory 1010 and a CPU 1020.

The computer 1000 also includes a hard disk drive interface 1030, a disk drive interface 1040, a serial port interface 1050, a video adapter 1060, and a network interface 1070. These units are connected by a bus 1080.

The memory 1010 includes a ROM (Read Only Memory) 1011 and a RAM (Random Access Memory) 1012. The ROM 1011 stores, for example, a boot program such as a BIOS (Basic Input Output System). The hard disk drive interface 1030 is connected to the hard disk drive 1090. The disk drive interface 1040 is connected to the disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS (Operating System) 1091, an application program 1092, a program module 1093, and program data 1094. That is, a program defining the kinds of processing of the processing apparatus 10 is implemented as a program module 1093 in which a code executable by a computer is described. The program module 1093 is stored in, for example, the hard disk drive 1090. For example, the program module 1093 for executing the same processing as the functional configuration in the processing apparatus 10 is stored in the hard disk drive 1090. The hard disk drive 1090 may be substituted by an SSD (Solid State Drive).

Setting data used in the processing in the embodiment explained above is stored in, for example, the memory 1010 or the hard disk drive 1090 as the program data 1094. The CPU 1020 reads the program module 1093 and the program data 1094 stored in the memory 1010 and the hard disk drive 1090 to the RAM 1012 according to necessity and executes the processing in the embodiment explained above.

Note that the program module 1093 and the program data 1094 are not limited to being stored in the hard disk drive 1090 and may be stored in, for example, a removable storage medium and read by the CPU 1020 via the disk drive 1100 or the like. Alternatively, the program module 1093 and the program data 1094 may be stored in another computer connected via a network (a LAN (Local Area Network) or a WAN (Wide Area Network), or the like). The program module and the program data 1094 may be read by the CPU 1020 from another computer via the network interface 1070.

### REFERENCE SIGNS LIST

10 PROCESSING APPARATUS
11 SEED SELECTION UNIT
12 FIRST EXTRACTION UNIT
13 SECOND EXTRACTION UNIT
14 GENERATION UNIT
15 DECISION UNIT
141 FEATURE VALUE GENERATION UNIT
142 DETERMINATION UNIT
1421 DETERMINATION MODEL

1. A processing apparatus comprising:
a memory; and
processing circuitry configured to:
select a reliable site as a seed;
perform, a plurality of times, Web crawling for extracting an external link from the site selected as the seed;
perform, based on the site selected as the seed and a domain name of the external link extracted, Domain Name System crawling for extracting a Domain Name System record; and
specify a reliable site based on a feature of information extracted by the Web crawling and/or a feature of information extracted by the Domain Name System crawling and generate an allow list indicating the reliable site.

2. The processing apparatus according to claim 1, wherein the processing circuitry is further configured to:
extract a link by recursively repeating the Web crawling up to a designated layer based on the site selected as the seed, determine, according to a domain name of the extracted link, whether the extracted link is an external link, and extract server certificate information and Web content information when the extracted link is the external link,
generate, based on the information extracted by the Web crawling and the information extracted by the Domain Name System crawling, for a determination target domain name, a first feature value indicating features of presence or absence of a Domain Name System record extracted by the Domain Name System crawling and content of the Domain Name System record and a second feature value indicating a feature of content of the server certificate information, and
determine, based on a feature value including a part or all of the first feature value and the second feature value, whether the determination target domain name is reliable.

3. The processing apparatus according to claim 1, wherein the processing circuitry is further configured to:
generate, based on the information extracted by the Web crawling, for a determination target domain name, a third feature value indicating a feature of a context of a title of a Web site acquired by the Web crawling and/or of a sentence set as content of the Web site extracted by the Web crawling, and
a fourth feature value indicating a feature of a context of a document of link text set in a link source of a back link at a time when being linked to the Web site extracted by the Web crawling, and
determine, based on a feature value including a part or all of the third feature value and the fourth feature value, whether the determination target domain name is reliable.

4. The processing apparatus according to claim 1, wherein the processing circuitry is further configured to:
generate, based on the information extracted by the Web crawling, for a determination target domain name, a fifth feature value indicating a feature of a number of Web sites linked to the Web site extracted by the Web crawling and a domain name of a back link source, and
determine, based on a feature value including a part or all of the fifth feature value, whether the determination target domain name is reliable.

5. The processing apparatus according to claim 1, wherein the processing circuitry is further configured to, when a feature value indicating features of a determination target domain name and a Web site concerning the domain name is input, determine, using a machine learning model for outputting a determination result as to whether a site having the domain name is reliable, whether the Web site extracted by the Web crawling is reliable.

6. A processing method executed by a processing apparatus, comprising:
selecting a reliable site as a seed;
performing, a plurality of times, Web crawling for extracting an external link from the site selected as the seed;
performing, based on the site selected as the seed and a domain name of the external link extracted Domain Name System crawling for extracting a Domain Name System record; and
specifying a reliable site based on a feature of information extracted by the Web crawling and/or a feature of information extracted by the Domain Name System crawling and generating an allow list indicating the reliable site.

7. A non-transitory computer-readable recording medium storing therein a processing program that causes a computer to execute a process comprising:
selecting a reliable site as a seed;
performing, a plurality of times, Web crawling for extracting an external link from the site selected as the seed;
performing, based on the site selected as the seed and a domain name of the external link extracted Domain Name System crawling for extracting a Domain Name System record; and
specifying a reliable site based on a feature of information extracted by the Web crawling and/or a feature of information extracted by the Domain Name System crawling and generating an allow list indicating the reliable site.
